(19) United States
(12) Patent Application Publication
(10) Pub. No.: US 2008/0256810 A1
(43) Pub. Date: Oct. 23, 2008

(54) ANGLE MEASUREMENT TOOL

(76) Inventor: TENNY M. AKIHARY, Richmond, KY (US)

Correspondence Address: WOOD AND EISENBERG, PLLC, 6911 RICHMOND HIGHWAY, SUITE 403, Alexandria, VA, 22306, US

(21) Appl. No.: 12/101,162

(22) Filed: Apr. 11, 2008

Related U.S. Application Data
(60) Provisional application No. 60/912,391, filed on Apr. 17, 2007.

(51) Int. Cl. G01C 15/12; G01B 3/56

(52) U.S. Cl. 33/1 N; 33/1 G; 33/413

(57) ABSTRACT

An angle measuring device for use in preparing construction layouts, which includes: a generally flat outer circular plate, a generally flat inner circular plate, a first pair of string connectors, a second pair of string connectors, and a means for positioning the angle measuring device over a selected point. The outer and inner circular plates share a common plane. The outer circular plate defines an outer circumference, an inner circumference, and a circular interior aperture. The inner circumference is marked up with indicia for measuring angles. The inner circular plate rotates freely inside the inner circumference and about the center-hole.

### CROSS-REFERENCE TO RELATED APPLICATIONS

This application claims the benefit of priority from U.S. Provisional Patent Application Ser. No. 60/912,391 (filed Apr. 17, 2007).

### STATEMENT REGARDING FEDERALLY SPONSORED RESEARCH OR DEVELOPMENT

Not Applicable.

### FIELD OF THE INVENTION

This invention relates generally to angle measurement tools.

### BACKGROUND OF THE INVENTION

As noted in U.S. Pat. No. 6,212,782, prior to any building project it is necessary to first establish the building lines, i.e., locate reference points and erect building lines for construction of a structure such as, but not limited to, a building, a deck, porch, drive way, etc.

Determining angles and structure layouts is often a difficult task for non-professional builders. For example, to measure out a 90° angle a non-professional builder might use a 3 by 4 by 5 feet triangle. Such devices are cumbersome to use and are easily damaged. Thus, there is a need for a device that offers a less cumbersome way to measure out angles, e.g., from 0° to 180° or from 0° to 90°, and determine stake or pole positions.

### BRIEF DESCRIPTION OF THE DRAWINGS

FIG. 1 shows an environmental view of an angle measurement tool according to the present invention.

FIG. 2 shows a perspective view of a preferred configuration of the angle measurement tool according to the present invention.

FIG. 3 shows a perspective view of an embodiment of the invention.

FIG. 4 shows a perspective view of an embodiment of the invention.

FIG. 5 shows a perspective view of an embodiment of the invention.

FIG. 6 shows an exploded view of an embodiment of the present invention.

FIG. 7 shows an exploded view of an embodiment of the present invention.

FIG. 8A shows an exploded view of an embodiment of the present invention.

FIG. 8B shows a side section view of an embodiment of the present invention.

FIG. 9 shows top and underside views of an inner circular plate according to one embodiment of the present invention.

FIG. 10A shows a perspective view of the upper side of an outer circular plate member according to the present invention.

FIG. 10B shows a perspective view of the lower side of an outer circular plate member of FIG. 10A.

FIG. 11A shows a partial section view of the angle measurement tool according to one embodiment of the present invention.

FIG. 11B shows a partial section view of the angle measurement tool according to one embodiment of the present invention.

FIG. 12 shows a side section view of the angle measurement tool according to one embodiment of the present invention.

FIG. 13 shows a side section view of the angle measurement tool according to one embodiment of the present invention.

FIG. 14 shows a partial cutaway view of the angle measurement tool according to one embodiment of the present invention.

FIG. 15 shows a partial cutaway view of the angle measurement tool according to one embodiment of the present invention.

FIG. 16 shows a table listing part numbers.

### SUMMARY OF THE INVENTION

An angle measuring device for use in preparing construction layouts. The angle measuring device includes: a generally flat outer circular plate, a generally flat inner circular plate, a first pair of string connectors, a second pair of string connectors, and a means for positioning the angle measuring device over a selected point. The outer and inner circular plates share a common plane. The outer circular plate defines an outer circumference, an inner circumference, and a circular interior aperture. The inner circumference has a first predetermined cross-section shape and is marked up with indicia for measuring angles. The inner circular plate defines a center-hole, and a circumference with a second predetermined cross-section shape selected to complement the first predetermined cross-section shape of the inner circumference of the outer circular plate thereby enabling the inner circular plate to be rotated inside the inner circumference and about the center-hole.

### DETAILED DESCRIPTION OF THE INVENTION

This invention is directed to an angle measurement tool for preparing construction layouts. The angle measurement tool of the invention is denoted generally by the numeric label “100”.

Referring to the Figures in general, the angle measuring device 100 comprises an outer circular plate 120, an inner circular plate 140, and an optional plumb-bob 160. The outer circular plate 120 is a generally planar disk-shaped plate in the shape of a large washer with a circular central aperture 170 in the middle.

Still referring to the Figures in general, the inner circular plate 140 sits inside the outer circular plate 120, and more particularly inside the circular central aperture 170. The inner circular plate 140 can be rotated with respect to the outer circular plate 120, and vice versa, to measure out angles of interest.

The outer circular plate 120 defines top and bottom sides 185 and 200, respectively. The outer circular plate 120 defines an outer circumference 220 and an inner circumference 240. The inner circumference defines a first predetermined cross-section shape. The inner circumference 240 defines the circular central aperture 170. The inner circumference 240 is marked up with indicia 300 for measuring angles; the indicia 300 can be on the top side 185 or bottom side 200. A first pair of string connectors 320 and 340 are located 180° apart on the top side 185 or bottom side 200 of the outer circular plate 120.

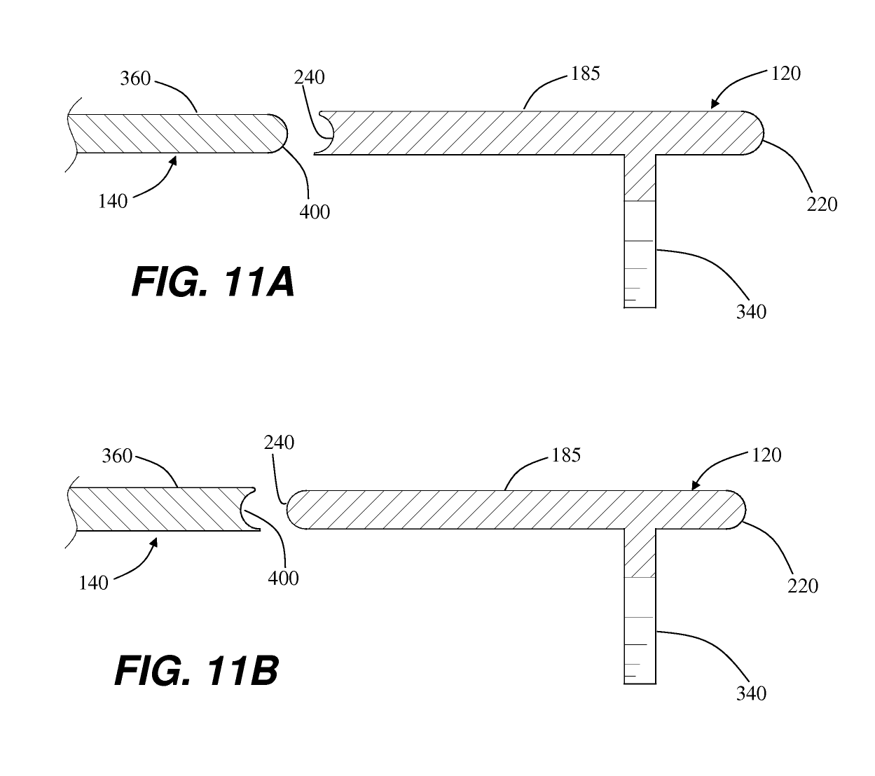

The inner circular plate 140 has a top side 360 and a bottom side 380. The inner circular plate 140 fits in the circular interior aperture 170. The inner circular plate 140 defines a center-hole 390. The inner circular plate 140 has a circumference 400. The circumference 400 defines a second predetermined cross-section shape. The second predetermined cross-section shape of circumference 400 is chosen to complement the first cross-section shape of the inner circumference 240 of the outer circular plate 120 and vice versa (see FIGS. 11A and 11B). The inner circular plate 140 fits snuggly inside aperture 170 with circumference 400 abutting against inner circumference 240 of outer circular plate 120, the tolerances are such that the inner circular plate 140 can rotate freely about center-hole 390 without falling out of aperture 170.

The circumference 400 of the inner circular plate 140 is marked up with a reference mark 440; reference mark 440 can be located on the top 360 or bottom 380 sides of inner circular plate 140. Second pair of string connectors 460 and 480 are located 180° apart on the top 360 or bottom side 380 of inner circular plate 140.

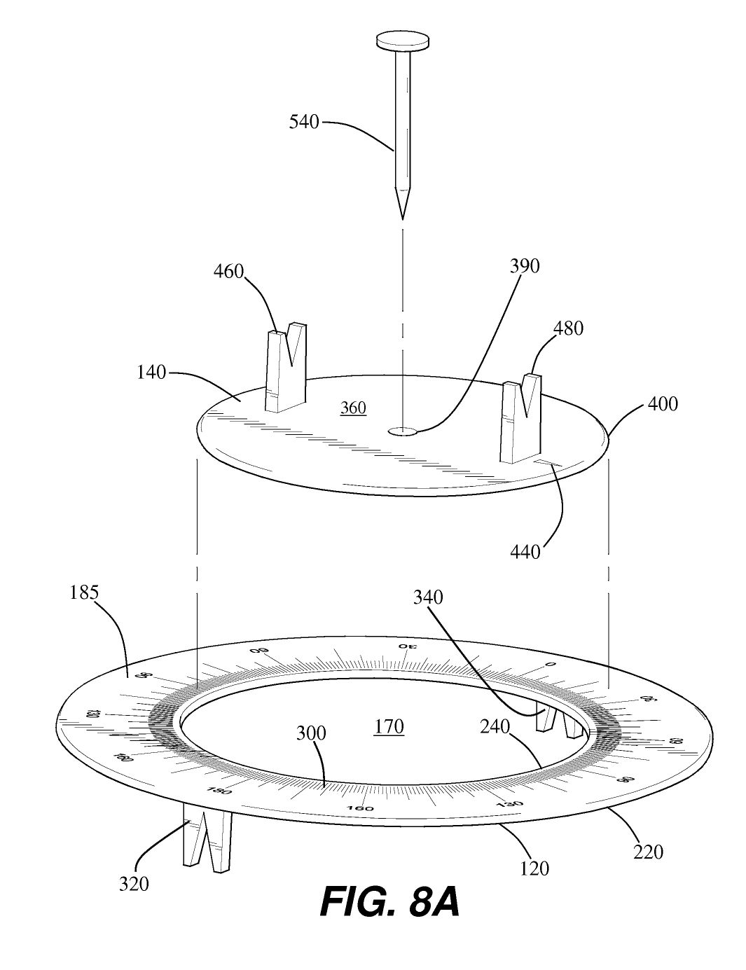

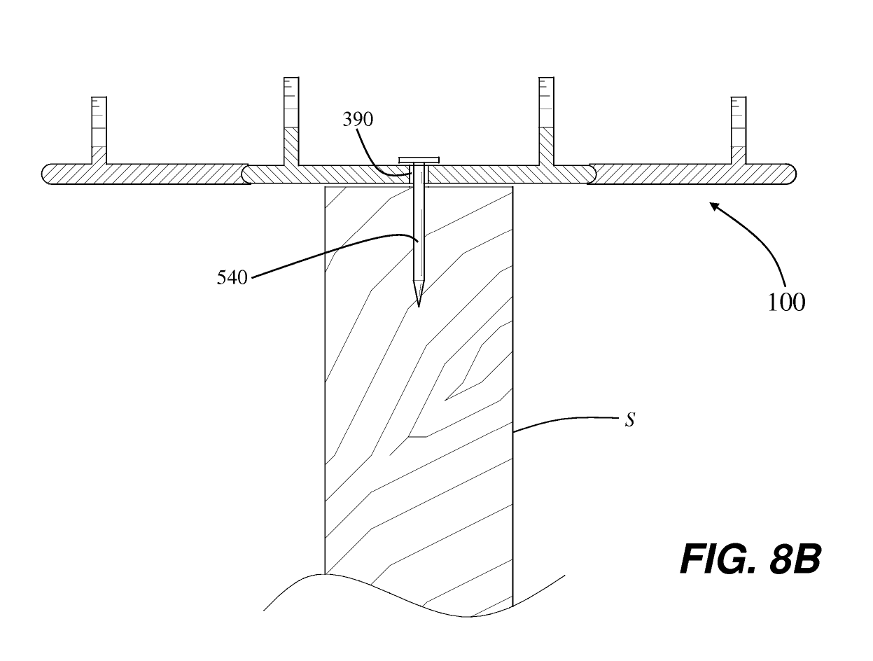

The optional plumb-bob 160 is attached by a plumb-string 165 to center-hole 390 and during use typically hangs from the bottom side 380 of inner circular plate 140. The optional plumb-bob 160 is used to mark out correct locations of poles or stakes while preparing a construction layout. The optional plumb-bob 160 is particularly useful when working on uneven or inclined ground to help ensure stakes placed in the ground are placed upright. A nail 540 can be used in place of optional plumb-bob 160, wherein a nail 540 is placed through center-hole 390 (see, e.g., FIG. 8A).

The second pair of string connectors 460 and 480, reference mark 440, and center-hole 390 are aligned in a straight line. During use of the device 100 a first string 500 is attached between and extends from the first pair of string connectors 320 and 340 located on the outer circular plate 120; and a second string 520 is attached between and extends from the second pair of string connectors 460 and 480 located on the inner circular plate 140. The inner circular plate 120 defines a center-hole 390.

The first pair of string connectors 320 and 340 share a first common height H1 (i.e., H one), and the second pair of string connectors 460 and 480 share a second common height H2. In a preferred embodiment the first common height H1 is less than the second common height H2 (i.e., H1<H2; and conversely, H2>H1). Alternatively, H1>H2 (and conversely, H2<H1). It is possible for H1=H2, but this would mean the first and second strings FS1 and FS2 would be in the same horizontal plane and would entail problems when the inner circular plate 140 is rotated with a first string FS1 attached to the first pair of string connectors 320 and 340, and a second string FS2 is attached to second pair of string connectors 460 and 480; specifically, the strings FS1 and FS2 would likely come into direct contact and tangle or obstruct each other.

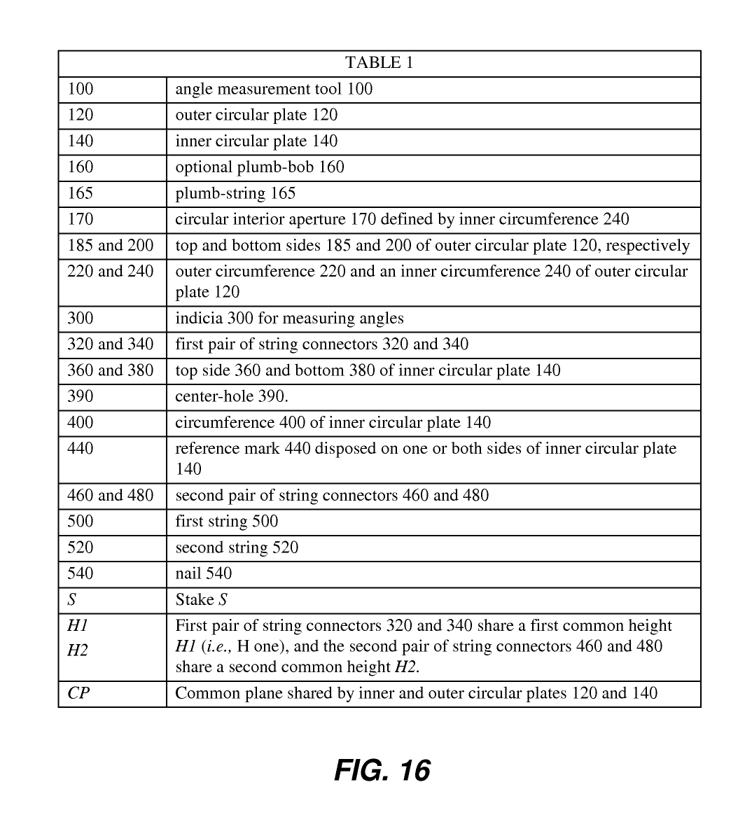

Referring now to the Figures with regard to which the meaning of labels and numbers shown in the Figures are described in Table 1 (see FIG. 16).

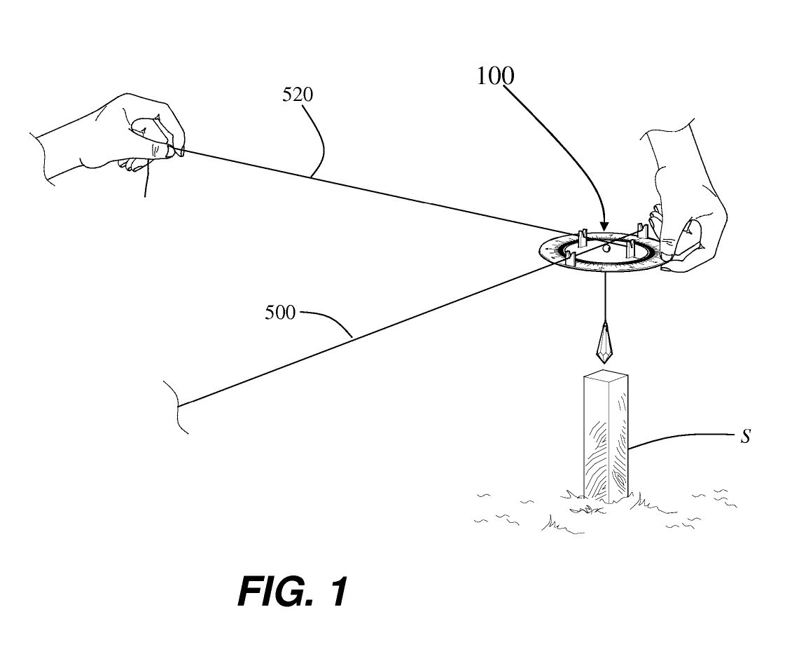

FIG. 1 shows an environmental view of the angle measurement tool 100, which is shown deployed above a reference state S. The angle measurement tool 100 can be used to layout stakes or poles in preparing construction layouts. For example, the angle measurement tool 100 of the invention can be used to layout a deck.

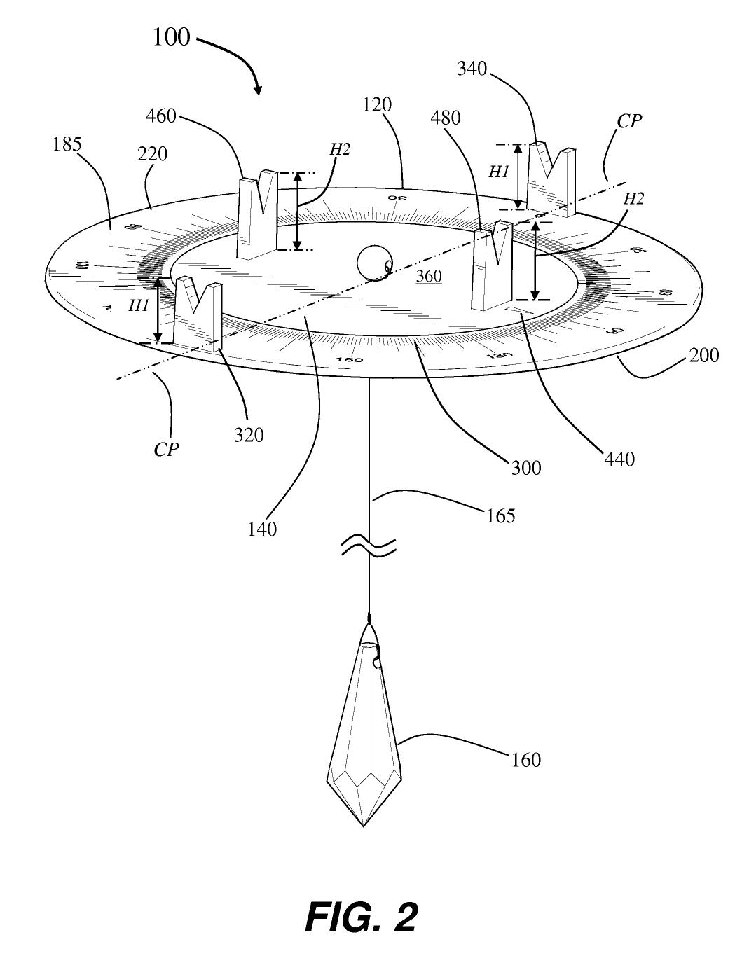

FIG. 2 shows a perspective view of a preferred configuration of the angle measurement tool 100. More specifically, the first pair of string connectors 320 and 340, and the second pair of string connectors 460 and 480 are shown on the top surfaces of angle measurement tool 100, i.e., on the opposite side from the optional plumb-bob 160. More specifically, the first pair of string connectors 320 and 340 are shown 180° apart on the top side 185 of the outer circular plate 120; and the second pair of string connectors 460 and 480 are shown 180° apart on the top side 360 of the inner circular plate 140. Reference mark 440 is shown disposed on top side surface 360 of inner circular plate 140 proximate to string connector 480, and aligned with the second pair of string connectors 460 and 480. As will become clear, the first and second pair of string connectors can be located on the top or bottom surfaces of the outer and inner circular plates 120 and 140, respectively. Explanation of the part numbers shown in FIG. 2 are found in Table 1.

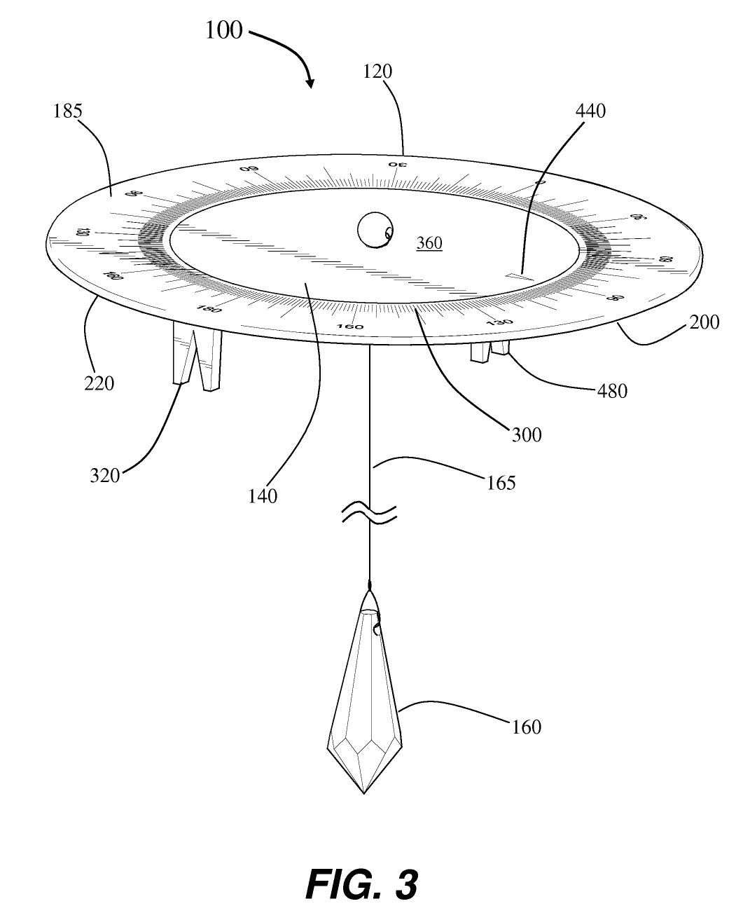

FIG. 3 shows a perspective view of an embodiment of the invention in which the first pair of string connectors 320 and 340, and the second pair of string connectors 460 and 480 are located on the lower surfaces of angle measurement tool 100, i.e., on the same side as the optional plumb-bob 160. More specifically, first pair of string connectors 320 and 340 are located on the bottom side 200 of outer circular plate 120. Only string connectors 320 and 480 are visible; string connectors 340 and 460 are out of view. Explanation of the part numbers shown in FIG. 3 are found in Table 1.

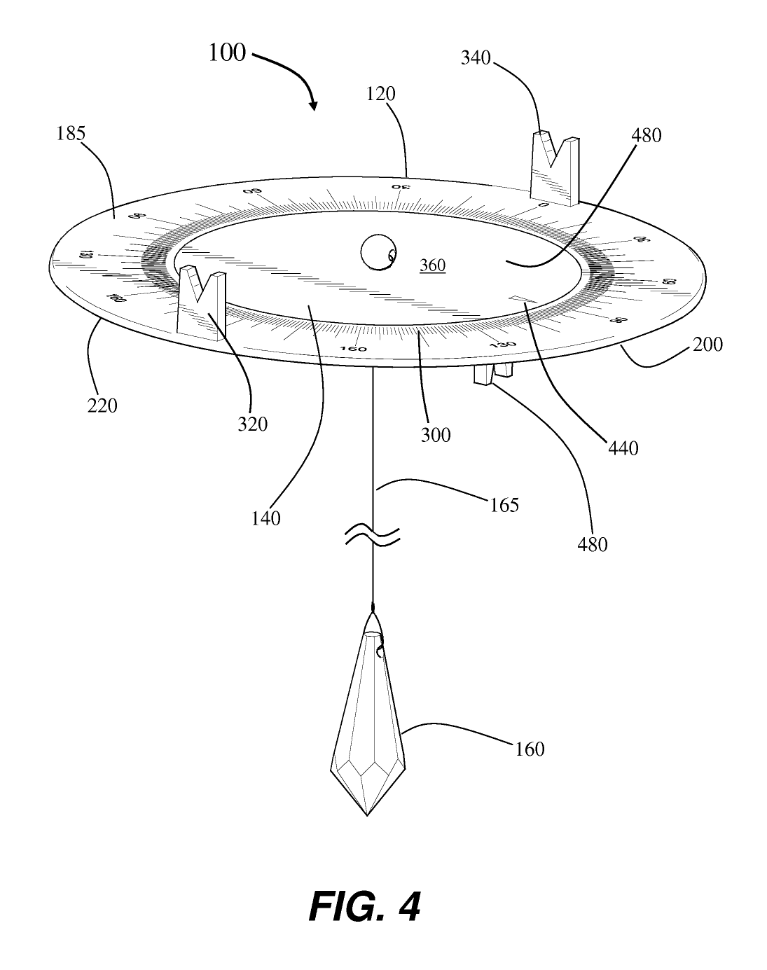

FIG. 4 shows a perspective view of an embodiment of the invention in which the first pair of string connectors 320 and 340 are located on the top side 185 of outer circular plate 120; and the second pair of string connectors 460 and 480 are located on the bottom side 380 of inner circular plate 140; only string connectors 320, 340 and 480 are visible; string connector 460 is out of view. Explanation of the part numbers shown in FIG. 4 are found in Table 1.

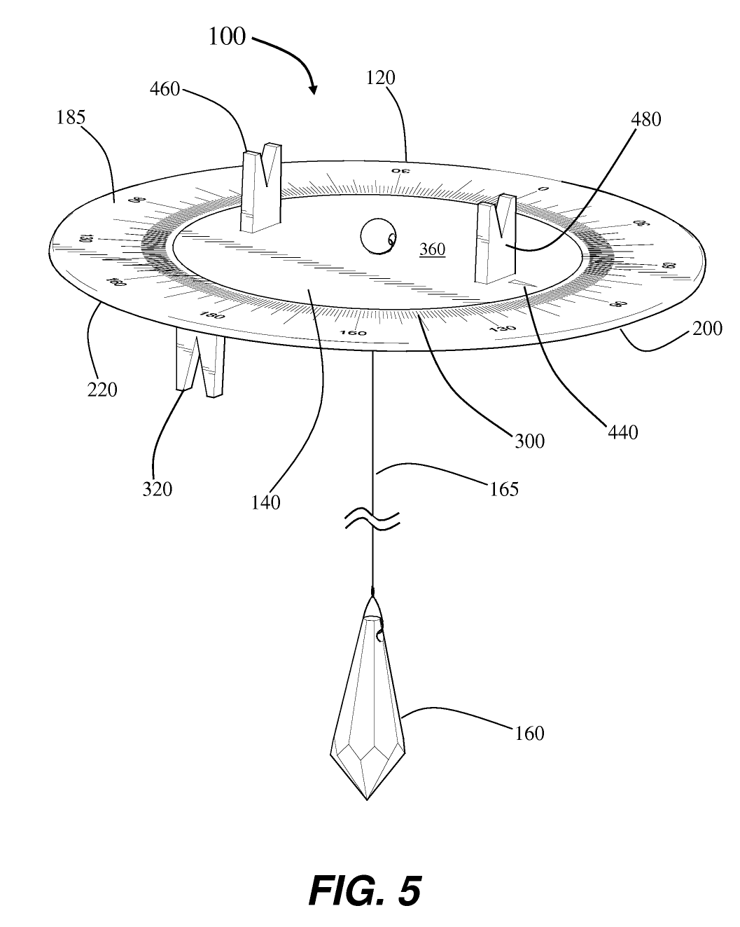

FIG. 5 shows a perspective view of an embodiment of the invention in which the first pair of string connectors 320 and 340 are located on the bottom side 200 of outer circular plate 120; and the second pair of string connectors 460 and 480 are located on the top side 360 of inner circular plate 140; only string connectors 320, 460 and 480 are visible; string connector 340 is out of view. Explanation of the part numbers shown in FIG. 5 are found in Table 1.

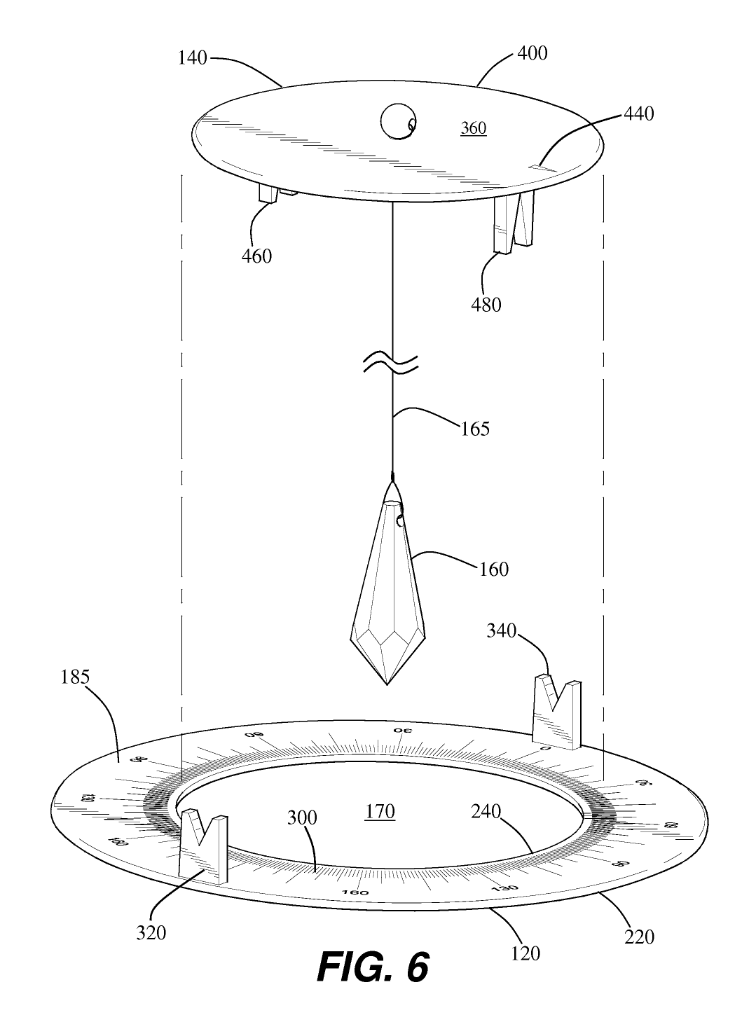

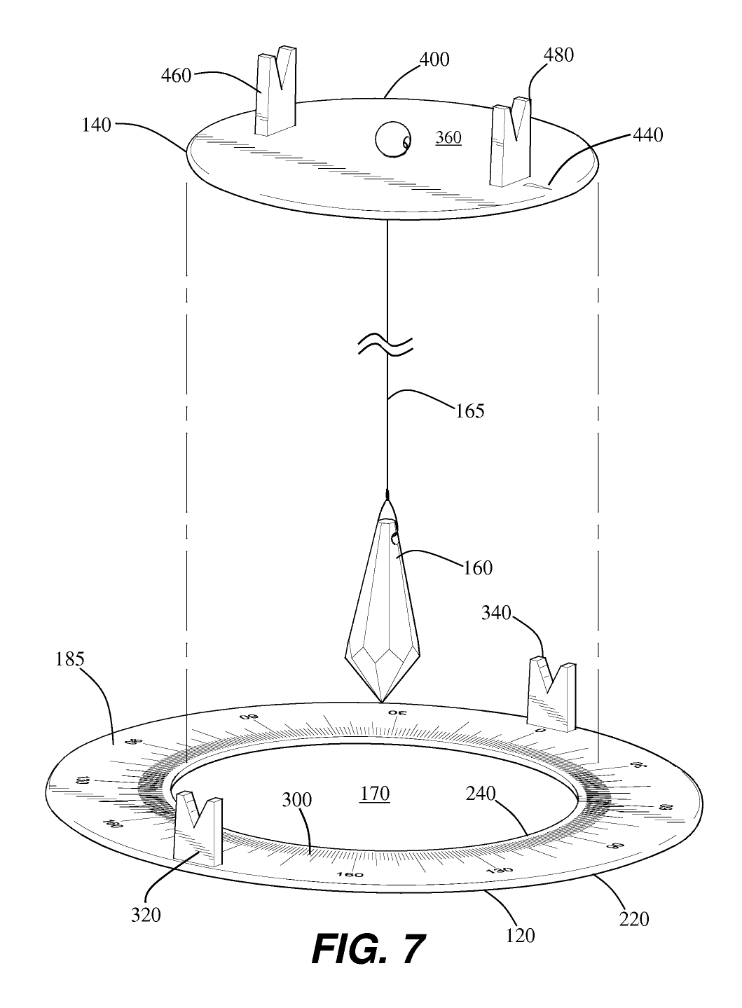

FIGS. 6 and 7 show exploded views of two configurations of the first and second pair of string connectors with respect to the top and bottom surfaces of angle measurement tool 100. Explanation of the part numbers shown in FIGS. 6 and 7 are found in Table 1.

FIGS. 8A and 8B show a version of the angle measurement tool 100 where a nail 540 is used in place of the optional plumb-bob 160. The nail 540 is placed through center-hole 390 and thence into, for example, a stake S. Explanation of the part numbers shown in FIGS. 8A and 8B are found in Table 1.

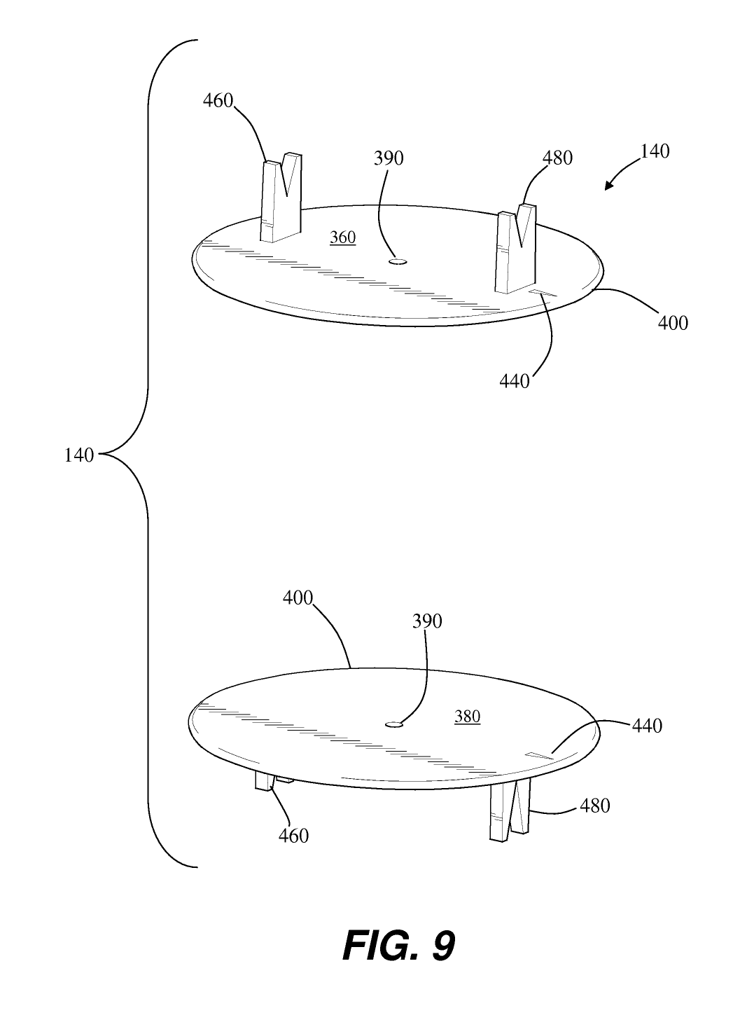

FIG. 9 shows the top side 360 and bottom side 380 of inner circular plate 140. The reference mark 440 can be disposed on either side of the inner circular plate 140 as shown in FIG. 9. Explanation of the part numbers shown in FIG. 9 are found in Table 1.

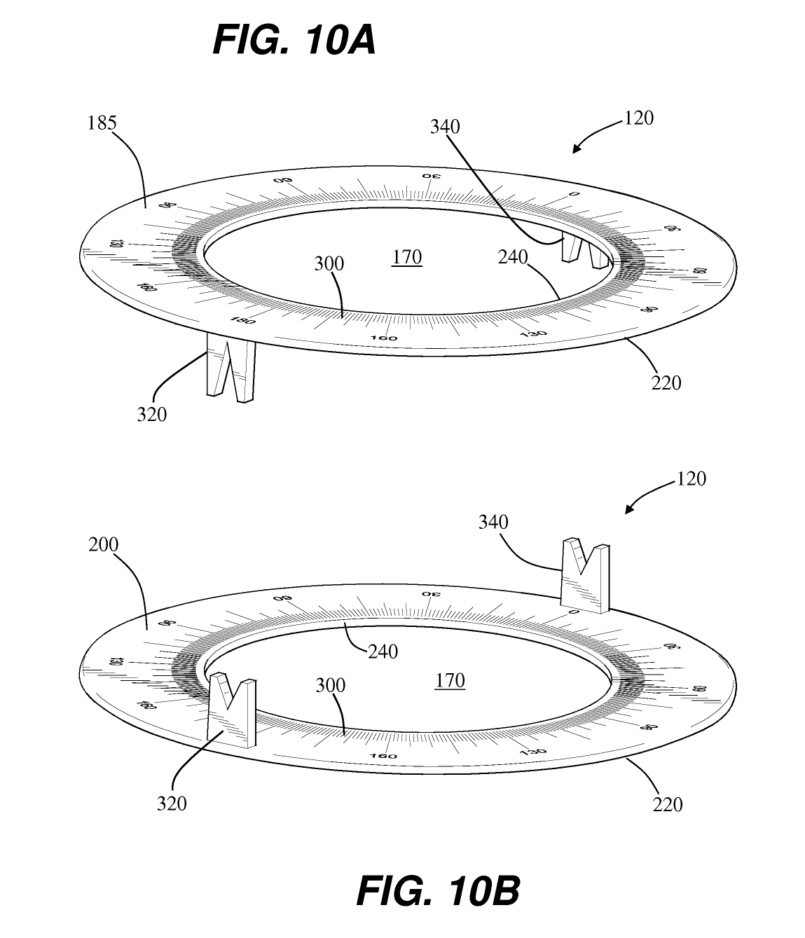

FIGS. 10A and 10B respectively show perspective views of top and bottom sides 185 and 200 of outer circular plate 120. Either sides 185 and 200 can be marked up with indicia 300 for measuring angles, the indicia is aligned with the inner circumference 240. Explanation of the part numbers shown in FIGS. 10A and 10B are found in Table 1.

FIGS. 11A and 11B respectively show examples of how the inner circular plate 140 fits snuggle inside the inner circumference 400 of the outer circular plate 120. More specifically, circumferences 240 and 400 respectively define first and second predetermined cross-section shapes, wherein the first and second predetermined cross-section shapes complement each other. For example, in FIG. 11A the circumference 240 has a first predetermined cross-section shape in the form of a concave shape, and circumference 400 has a second predetermined cross-section shape in the form of a convex shape that complements the first predetermined cross-section shape. The tolerances are such that the inner circular plate 140 rotates freely about center-hole 390 (shown in FIG. 9). More specifically, the plates 120 and 140 share the same common plane CP and the inner circular plate 140 is rotatable in the common plane CP (shown in FIG. 2). Thus, the inner circular plate 140 is rotatable about center-hole 390 without falling out of aperture 170 (shown in, e.g., FIG. 6). Explanation of the part numbers shown in FIGS. 11A and 11B are found in Table 1.

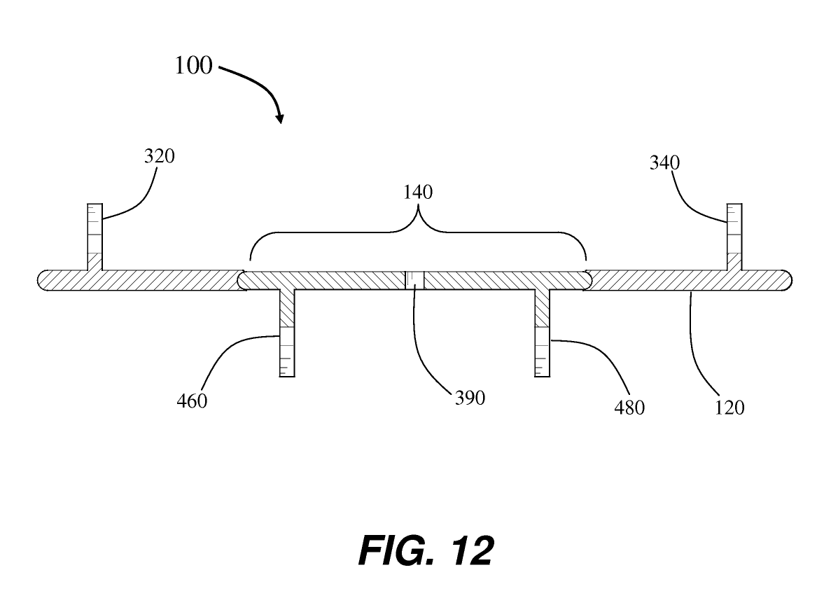

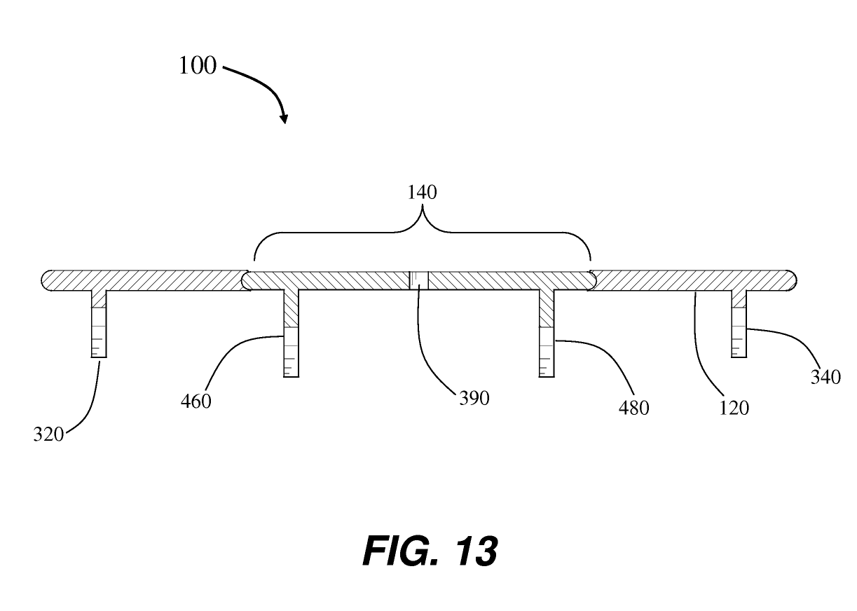

FIGS. 12 and 13 show section views of angle measurement tool 100. In FIG. 12 the first and second pair of string connectors are respectively shown in an up and down configuration whereas in FIG. 13 both pairs of string connectors are shown in a down configuration. Explanation of the part numbers shown in FIGS. 12 and 13 are found in Table 1.

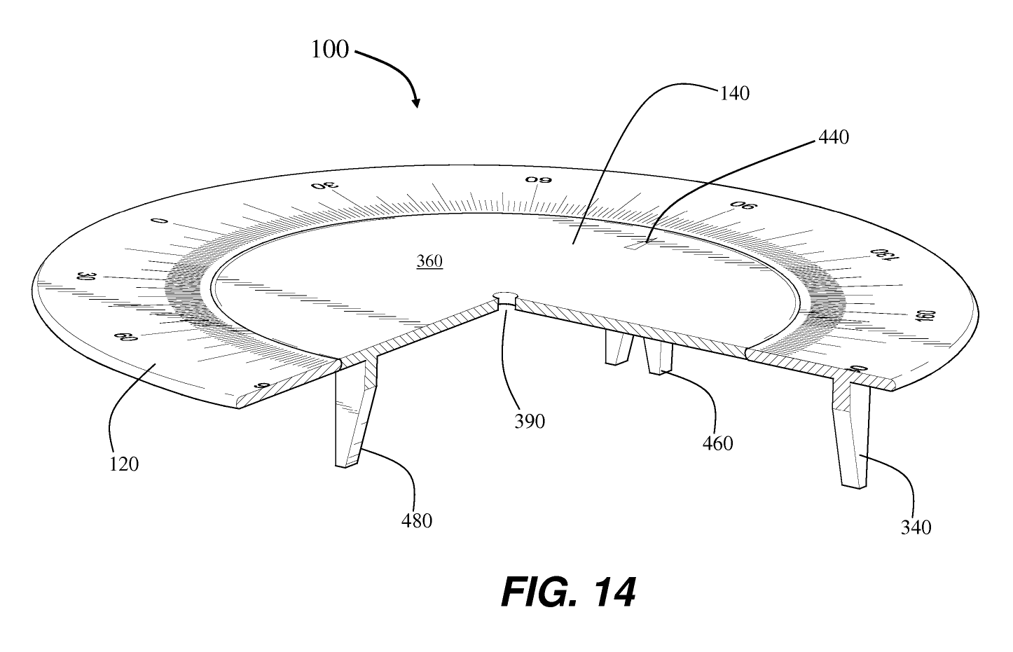

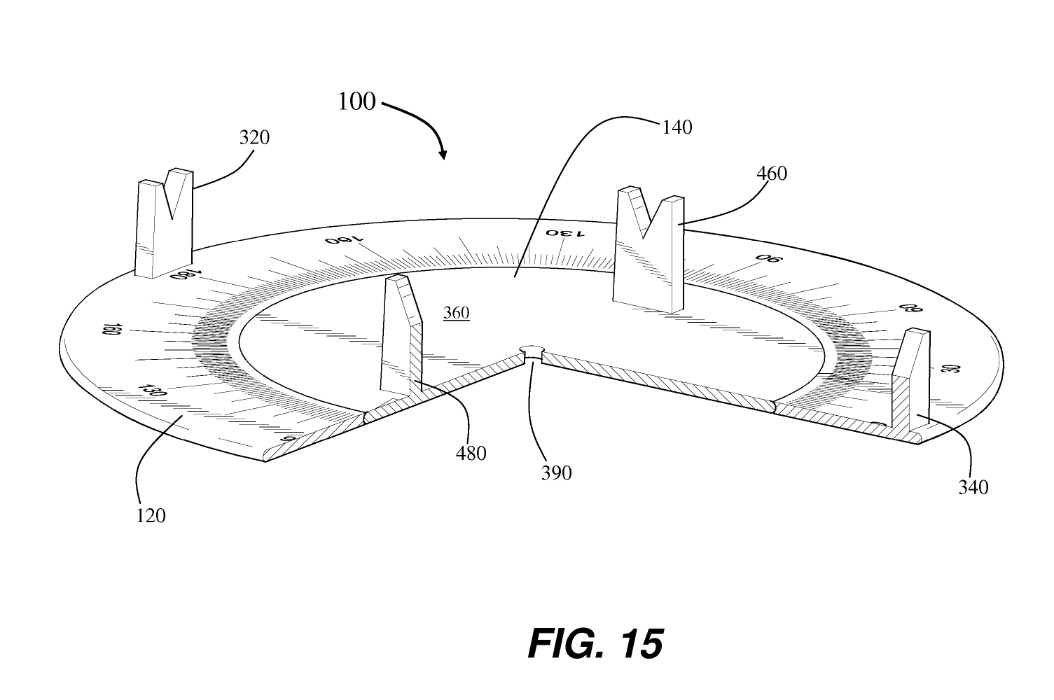

FIGS. 14 and 15 show a partial cutaway views of the angle measurement tool 100. Explanation of the part numbers shown in FIGS. 14 and 15 are found in Table 1.

In one aspect of the invention the angle measuring device 100 comprises: a generally flat outer circular plate 120 having a top side 185 and a bottom side 200, wherein the outer circular plate 120 defines an outer circumference 220 and an inner circumference 240, wherein the inner circumference 240 of the outer circular plate 120 defines a circular interior aperture 170, the inner circumference 240 of the outer circular plate 120 defines a first predetermined cross-section shape, wherein the inner circumference 240 of the outer circular plate 120 is marked up with indicia 300 for measuring angles; a generally flat inner circular plate 140 having a top side 360 and a bottom side 380, the inner circular plate 140 fits inside the circular interior aperture 170, the outer 120 and inner 140 circular plates share a common plane CP, the inner circular plate 140 defines a center-hole 390, the inner circular plate 140 defines a circumference 400 with a second predetermined cross-section shape selected to complement the first predetermined cross-section shape of the inner circumference 240 of the outer circular plate 120 thereby enabling the inner circular plate 140 to be rotated inside the inner circumference 240 and about the center-hole 390, wherein a reference mark 440 is disposed on at least one of the sides of the inner circular plate 140; a first pair of string connectors 320 and 340, wherein the first pair of string connectors 320 and 340 are located 180° apart on opposite sides of the same side of the outer circular plate 120; a second pair of string connectors 460 and 480, wherein the second pair of string connectors 460 and 480 are located 180° apart on opposite sides of the same side of the inner circular plate 140, wherein said reference mark 440 is located in alignment with said second pair of string connectors (see, e.g., FIG. 2); and a means for positioning the angle measuring device 100 over a selected point.

The selected point is any desired point on the ground, e.g., a stake S. The means for positioning the angle measuring device 100 over a selected point can be any suitable means such as a plumb-bob 160 in combination with a plumb-string 165. Alternatively, the means for positioning the angle measuring device 100 over a selected point, such as a stake S, can be a nail 540 (see, e.g., FIGS. 8A and 8B).

In another aspect of the invention the angle measuring device 100 comprises: a generally flat outer circular plate 120 having a top side 185 and a bottom side 200, wherein the outer circular plate 120 defines an outer circumference 220 and an inner circumference 240, wherein the inner circumference 240 of the outer circular plate 120 defines a circular interior aperture 170, the inner circumference 240 of the outer circular plate 120 defines a first predetermined cross-section shape, wherein the top side 185 of the outer circular plate 120 is marked up with indicia 300 for measuring angles; a generally flat inner circular plate 140 having a top side 360 and a bottom side 380, the inner circular plate 140 fits inside the circular interior aperture 170, the outer and inner circular plates 120 and 140 share a common plane CP, the inner circular plate 140 defines a center-hole 390, the inner circular plate 140 defines a circumference 400 with a second predetermined cross-section shape selected to complement the first predetermined cross-section shape of the inner circumference 240 of the outer circular plate 120 thereby enabling the inner circular plate 140 to be rotated inside the inner circumference 240 and about the center-hole 390, wherein a reference mark 440 is disposed on said inner circular plate 140 such that the reference mark 440 is visible from the top side 360 of said inner circular plate 140; a first pair of string connectors 320 and 340, wherein the first pair of string connectors 320 and 340 are located 180° apart on opposite sides on the top side 185 of the outer circular plate 180; a second pair of string connectors 460 and 480, wherein the second pair of string connectors 460 and 480 are located 180° apart on opposite sides on the top side 360 of the inner circular plate 140, wherein the reference mark 440 is located in alignment with the second pair of string connectors; and a means for positioning the angle measuring device over a selected point.

The invention being thus described, it will be evident that the same may be varied in many ways by a routineer in the applicable arts. Such variations are not to be regarded as a departure from the spirit and scope of the invention and all such modifications are intended to be included within the scope of the claims.

I claim:

1. An angle measuring device for use in preparing construction layouts, comprising:
a generally flat outer circular plate having a top side and a bottom side, wherein said outer circular plate defines an outer circumference and an inner circumference, wherein said inner circumference of said outer circular plate defines a circular interior aperture, said inner circumference of said outer circular plate defines a first predetermined cross-section shape, wherein said inner circumference of said outer circular plate is marked up with indicia for measuring angles;
a generally flat inner circular plate having a top side and a bottom side, said inner circular plate fits inside said circular interior aperture, said outer and inner circular plates share a common plane, said inner circular plate defines a center-hole, said inner circular plate defines a circumference with a second predetermined cross-section shape selected to complement the first predetermined cross-section shape of said inner circumference of said outer circular plate thereby enabling said inner circular plate to be rotated inside said inner circumference and about said center-hole, wherein a reference mark is disposed on at least one of the sides of said inner circular plate;
a first pair of string connectors, wherein said first pair of string connectors are located 180° apart on opposite sides of the same side of said outer circular plate;
a second pair of string connectors, wherein said second pair of string connectors are located 180° apart on opposite sides of the same side of said inner circular plate, wherein said reference mark is located in alignment with said second pair of string connectors; and
a means for positioning said angle measuring device over a selected point.

2. The angle measuring device of claim 1, wherein said means for positioning said angle measuring device over a selected point is a plumb-bob attached by a string to said center-hole in said inner circular plate.

3. The angle measuring device of claim 1, wherein said means for positioning said angle measuring device over a selected point is a nail, wherein said nail fits through said center-hole in said inner circular plate.

4. The angle measuring device of claim 1, wherein said first pair of string connectors are located on the top side of said outer circular plate, and said second pair of string connectors are located on the top side of said inner circular plate.

5. An angle measuring device for use in preparing construction layouts, comprising:
a generally flat outer circular plate having a top side and a bottom side, wherein said outer circular plate defines an outer circumference and an inner circumference, wherein said inner circumference of said outer circular plate defines a circular interior aperture, said inner circumference of said outer circular plate defines a first predetermined cross-section shape, wherein said top side of said outer circular plate is marked up with indicia for measuring angles;
a generally flat inner circular plate having a top side and a bottom side, said inner circular plate fits inside said circular interior aperture, said outer and inner circular plates share a common plane, said inner circular plate defines a center-hole, said inner circular plate defines a circumference with a second predetermined cross-section shape selected to complement the first predetermined cross-section shape of said inner circumference of said outer circular plate thereby enabling said inner circular plate to be rotated inside said inner circumference and about said center-hole, wherein a reference mark is disposed on said inner circular plate such that the reference mark is visible from the top side of said inner circular plate;
a first pair of string connectors, wherein said first pair of string connectors are located 180° apart on opposite sides on the top side of said outer circular plate 180;
a second pair of string connectors, wherein said second pair of string connectors are located 180° apart on opposite sides on the top side of said inner circular plate, wherein said reference mark is located in alignment with said second pair of string connectors; and
a means for positioning said angle measuring device over a selected point.

6. The angle measuring device of claim 5, wherein said means for positioning said angle measuring device over a selected point is a plumb-bob attached by a string to said center-hole in said inner circular plate.

7. The angle measuring device of claim 5, wherein said means for positioning said angle measuring device over a selected point is a nail, wherein said nail fits through said center-hole in said inner circular plate.

8. The angle measuring device of claim 5, wherein said angle measuring indicia is located proximate to said inner circumference of said outer circular plate.
